(19) United States
(12) Patent Application Publication
(10) Pub. No.: US 2008/0034106 A1
(43) Pub. Date: Feb. 7, 2008

(54) Reducing power consumption for bulk data transfers

(76) Inventors: Sanjay Bakshi, Beaverton, OR (US); Carol Bell, Beaverton, OR (US); Krishnan Rajamani, San Diego, CA (US); Brian Leete, Beaverton, OR (US)

Correspondence Address: Caven & Aghevli LLC;c/o Intellevate, P.O. Box 52050, Minneapolis, MN, 55402, US

(21) Appl. No.: 11/497,874

(22) Filed: Aug. 2, 2006

(51) Int. Cl. G06F 15/16; G06F 15/173

(52) U.S. Cl. 709/232; 709/238

(57) ABSTRACT

Methods and apparatus to provide reduced power consumption for bulk data transfers are described. In some embodiments, a query regarding data to be read on a bulk endpoint of a communication device is transmitted on an interrupt endpoint of the communication device. Other embodiments are also described and claimed.

### BACKGROUND

The present disclosure generally relates to the field of electronics. More particularly, some embodiments relate to a mechanism that reduces power consumption for bulk data transfers.

Bulk data transfers may be utilized to transmit relatively large amounts of data in a burst. However, depending upon the underlying transfer mechanisms, bulk data transfers may result in increased power consumption, even when no data is being transferred. For example, in a universal serial bus (USB) implementation (e.g., which may be in compliance with the Universal Serial Bus Specification, Revision 1.1, Sep. 23, 1998), bulk endpoints may be used to transfer relatively large amounts of bursty data.

To receive data over a bulk endpoint, a USB host may issue an input transaction to a USB device. If the device has data to send to the host, it responds to the transaction with the data. If the device does not have data to send to the host, it responds with a NAK (not acknowledged). In response to the NAK, the host may retry the transaction if there is enough time remaining in the current frame. This cycle may typically repeat up to the end of the given USB frame if the device does not send any data. Further, the scenario may reoccur in subsequent frames. During the time in which the host is repeatedly reissuing the NAKed transactions to the device, the host processor may be unable to enter lower power states. In one instance, a mobile computing device processor may be prevented from entering lower power states, in turn, resulting in a shortened battery life.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates various components of a networking environment, which may be utilized to implement some embodiments discussed herein.

FIGS. 2 and 5 illustrate block diagrams of embodiments of computing systems, which may be utilized to implement some embodiments discussed herein.

FIGS. 3 and 4 illustrate flow diagrams of methods in accordance with some embodiments.

### DETAILED DESCRIPTION

In the following description, numerous specific details are set forth in order to provide a thorough understanding of various embodiments. However, some embodiments of the invention may be practiced without the specific details. In other instances, well-known methods, procedures, components, and circuits have not been described in detail so as not to obscure the particular embodiments of the invention.

Some of the embodiments discussed herein may provide an efficient mechanism for reducing power consumption in computing systems that utilize bulk data transfers, e.g., in accordance with the Universal Serial Bus Specification, Revision 1.1, Sep. 23, 1998, and/or Universal Serial Bus Specification, Revision 2.0, Apr. 27, 2000 (including subsequent amendments to either revision). For example, some data (e.g., query and/or byte count information) may be exchanged between a host computing system and a communication device (such as a USB device, including a wired USB device or USB devices that are attached to a computing device (e.g., a portable or stationary computing system) via external USB ports or internal mini-PCIe slot (mini peripheral component interconnect express slot, which may at least partially comply with the PCI Express Specification Rev. 1.0a, June 2005)) through an interrupt endpoint (EP) instead of a bulk endpoint in some embodiments. This approach may allow various components (e.g., processor) of the host computing system to enter lower power states which, in turn, may result in reduced power consumption.

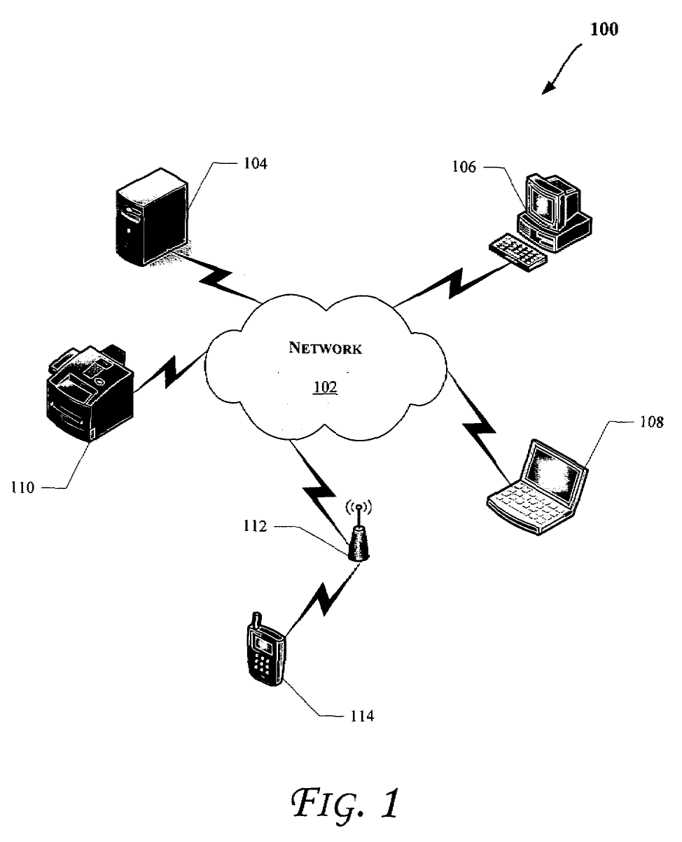

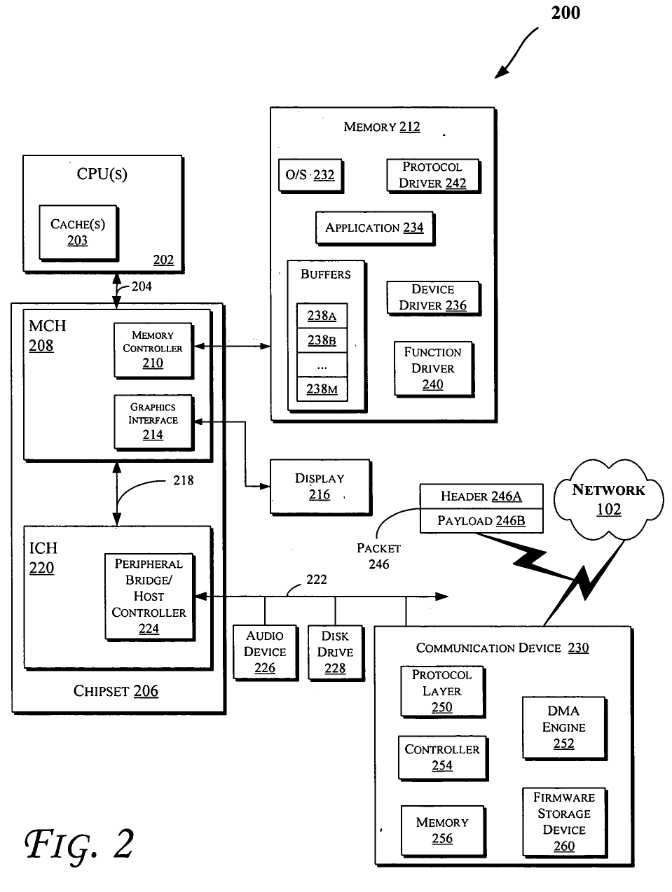

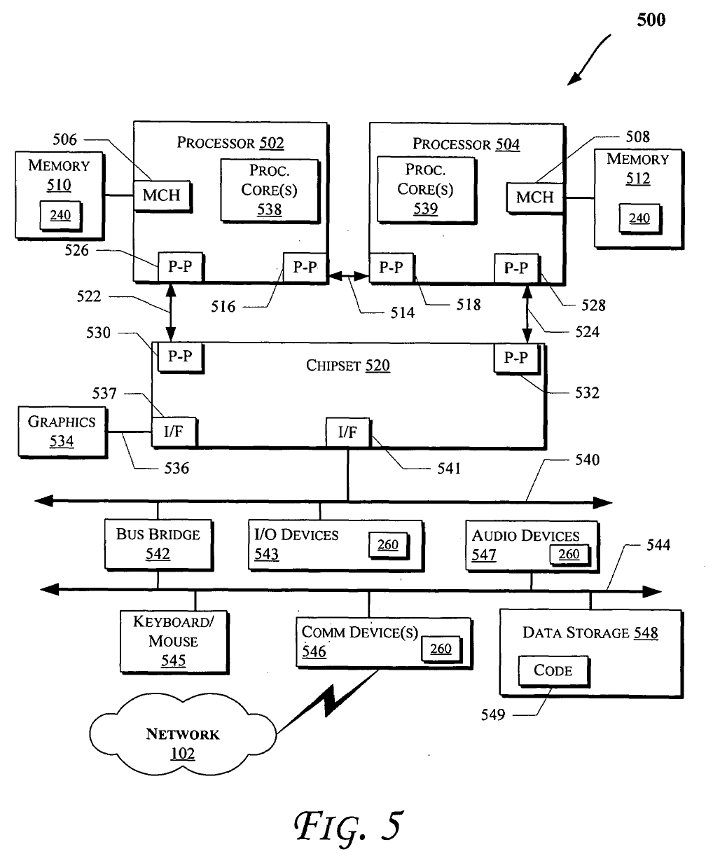

Moreover, the techniques discussed herein may be applied in various environments, such as the networking environment discussed with reference to FIG. 1 and/or the computing systems discussed with reference to FIGS. 2 and 5. More particularly, FIG. 1 illustrates various components of a networking environment 100, which may be utilized to implement some embodiments discussed herein. The environment 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, etc.), a wireless access point 112 (which may be a cellular basestation in one embodiment), a personal digital assistant or smart phone 114, a rack-mounted computing system (not shown), etc. The network 102 may be any type of type of a computer network including an intranet, the Internet, and/or combinations thereof.

The devices 104-114 may communicate with the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In some embodiments, the wireless access point 112 may include traffic management capabilities. Also, data communicated between the devices 104-114 may be encrypted (or cryptographically secured), e.g., to limit unauthorized access.

The network 102 may utilize any communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) such as a network interface card (NIC) or external network interface devices (e.g., having a separate physical enclosure and/or power supply than the computing system to which it is coupled).

FIG. 2 illustrates a block diagram of a computing system 200, in accordance with some embodiments. One or more of the devices 104-114 discussed with reference to FIG. 1 may comprise one or more of the components of the computing system 200. The computing system 200 may include one or more central processing unit(s) (CPUs) 202 (which may be collectively referred to herein as “processors 202” or more generally “processor 202”) coupled to an interconnection network (or bus) 204. The processors 202 may be any type of processor such as a general purpose processor, a network processor (which may process data communicated over a computer network (102)), etc. (including a reduced instruction set computer (RISC) processor or a complex instruction set computer (CISC)). Moreover, the processors 202 may have a single or multiple core design. The processors 202 with a multiple core design may integrate different types of processor cores on the same integrated circuit (IC) die. Also, the processors 202 with a multiple core design may be implemented as symmetrical or asymmetrical multiprocessors.

The processor 202 may include one or more caches (203), which may be private and/or shared in some embodiments. Generally, a cache stores data corresponding to original data stored elsewhere or computed earlier. To reduce memory access latency, once data is stored in a cache, future use may be made by accessing a cached copy rather than refetching or recomputing the original data. The cache 203 may be any type of cache, such a level 1 (L1) cache, a level 2 (L2) cache, a level 3 (L-3), a mid-level cache, a last level cache (LLC), etc. to store electronic data (e.g., including instructions) that is utilized by one or more components of the system 200.

A chipset 206 may additionally be coupled to the interconnection network 204. The chipset 206 may include a memory control hub (MCH) 208. The MCH 208 may include a memory controller 210 that is coupled to a memory 212. The memory 212 may store data, e.g., including sequences of instructions that are executed by the processor 202, or any other device in communication with components of the computing system 200. In some embodiments of the invention, the memory 212 may include one or more volatile storage (or memory) devices such as random access memory (RAM), dynamic RAM (DRAM), synchronous DRAM (SDRAM), static RAM (SRAM), etc. Nonvolatile memory may also be utilized such as a hard disk. Additional devices may be coupled to the interconnection network 204, such as multiple processors and/or multiple system memories.

The MCH 208 may further include a graphics interface 214 coupled to a display device 216, e.g., via a graphics accelerator. In some embodiments, the graphics interface 214 may be coupled to the display device 216 via an accelerated graphics port (AGP). In some embodiments of the invention, the display device 216 (which may include a flat panel display or a cathode ray tube) may be coupled to the graphics interface 214 through, for example, a signal converter that translates a digital representation of an image stored in a storage device such as video memory or system memory into display signals that are interpreted and displayed by the display. The display signals produced by the display device 216 may pass through various control devices before being interpreted by and subsequently displayed on the display device 216.

As shown in FIG. 2, a hub interface 218 may couple the MCH 208 to an input/output control hub (ICH) 220. The ICH 220 may provide an interface to input/output (I/O) devices coupled to the computing system 200. The ICH 220 may be coupled to a bus 222 through a peripheral bridge (or host controller) 224, such as a peripheral component interconnect (PCI) bridge, a universal serial bus (USB) controller, etc. The controller 224 may provide a data path between the processor 202 and peripheral devices. Other types of topologies may be utilized. Also, multiple buses may be coupled to the ICH 220, e.g., through multiple bridges or controllers. For example, the bus 222 may comply with the Universal Serial Bus Specification, Revision 1.1, Sep. 23, 1998, and/or Universal Serial Bus Specification, Revision 2.0, Apr. 27, 2000 (including subsequent amendments to either revision). Alternatively, the bus 222 may comprise other types and configurations of bus systems. Moreover, other peripherals coupled to the ICH 220 may include, in some embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), etc.

The bus 222 may be coupled to an audio device 226, one or more disk drive(s) 228, and a communication device 230 (which may be a NIC in some embodiments). Other devices may be coupled to the bus 222. Also, various components (such as the communication device 230) may be coupled to the MCH 208 in some embodiments of the invention. In addition, the processor 202 and the MCH 208 may be combined to form a single chip.

Additionally, the computing system 200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital versatile disk (DVD), flash memory, a magneto-optical disk, or other types of nonvolatile machine-readable media capable of storing electronic data (e.g., including instructions).

The memory 212 may include one or more of the following in some embodiments: an operating system (O/S) 232, application 234, device driver 236, buffers 238, function driver 240, and/or protocol driver 242. Programs and/or data stored in the memory 212 may be swapped into the disk drive 228 as part of memory management operations. The application(s) 234 may execute (e.g., on the processor(s) 202) to communicate one or more packets 246 with one or more computing devices coupled to the network 102 (such as the devices 104-114 of FIG. 1). In some embodiments, a packet may be a sequence of one or more symbols and/or values that may be encoded by one or more electrical signals transmitted from at least one sender to at least on receiver (e.g., over a network such as the network 102). For example, each packet 246 may have a header 246A that includes various information that may be utilized in routing and/or processing of the packet 246, such as a source address, a destination address, packet type, etc. Each packet may also have a payload 246B that includes the raw data (or content) the packet is transferring between various computing devices (e.g., the devices 104-114 of FIG. 1) over a computer network (such as the network 102).

In some embodiments, the application 234 may utilize the O/S 232 to communicate with various components of the system 200, e.g., through the device driver 236 and/or function driver 240. For example, the device driver 236 and function driver 240 may be used for different categories, e.g., device driver 236 may manage generic device class attributes, whereas the function driver 240 may manage device specific attributes (such as USB specific commands). In some embodiments, the device driver 236 may allocate one or more buffers (238A through 238M) to store packet data, such as the packet payload 246B. One or more descriptors (not shown) may respectively point to the buffers 238. In some embodiments, one or more of the buffers 238 may be implemented as circular ring buffers. Also, one or more of the buffers 238 may correspond to contiguous memory pages in some embodiments. Furthermore, a protocol driver 242 may implement a protocol driver to process packets communicated over the network 102, according to one or more protocols. In accordance with some embodiments, as discussed herein forth, reference to “function driver 240” may or may not refer to other types of drivers, e.g., including device driver 236, function driver 240, and/or protocol driver 242.

As illustrated in FIG. 2, the communication device 230 may include a network protocol layer 250 for implementing the physical communication layer to send and receive network packets to and from remote devices over the network 102. The network 102 may include any type of computer network such as those discussed with reference to FIG. 1. The communication device 230 may further include a direct memory access (DMA) engine 252, which may write packet data to buffers 238 to transmit and/or receive data over the network 102. Additionally, the communication device 230 may include a controller 254, which may include logic (such as a programmable processor) to perform communication device related operations. In some embodiments, the controller 254 may be a MAC (media access control) component. The communication device 230 may further include a memory 256, such as any type of volatile/nonvolatile memory (e.g., including one or more cache(s) and/or other memory types discussed with reference to memory 212).

In some embodiments, the communication device 230 may include a firmware storage device 260 to store firmware (or software) that may be utilized in management of various functions performed by components of the communication device 230. For example, the firmware may be used to configure various operations such as those discussed with reference to FIG. 5. The storage device 260 may be any type of a storage device such as a non-volatile storage device. For example, the storage device 260 may include one or more of the following: ROM, PROM, EPROM, EEPROM, disk drive, floppy disk, CD-ROM, DVD, flash memory, a magneto-optical disk, or other types of nonvolatile machine-readable media capable of storing electronic data (e.g., including instructions).

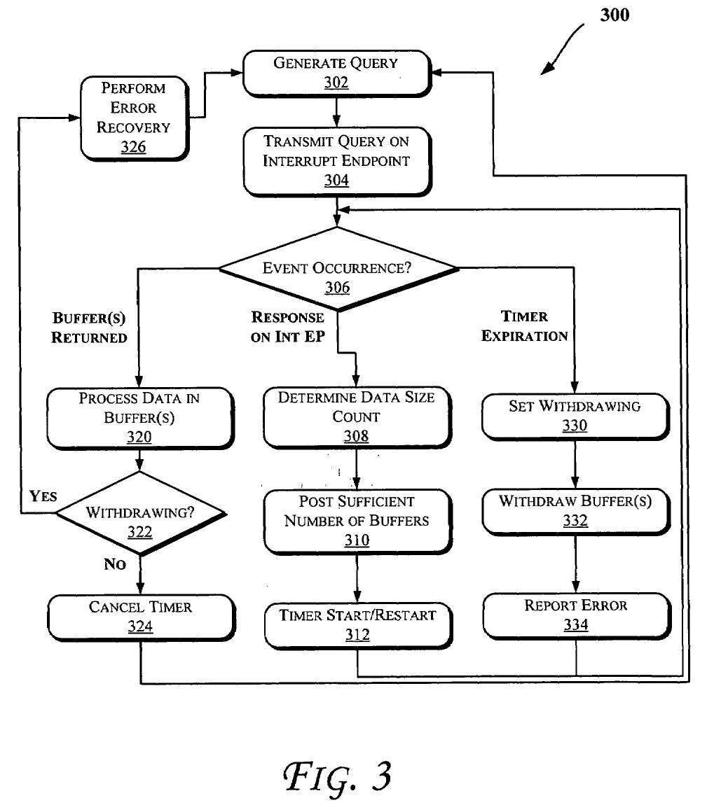

FIG. 3 illustrates a flow diagram of a method 300, according to some embodiments. In some embodiments, various components discussed with reference to FIGS. 1-2 and 5 may be utilized to perform one or more of the operations discussed with reference to FIG. 3. For example, the processor(s) 202 may be configured to perform one or more of the operations discussed with reference to FIG. 3, e.g., in accordance with instructions or commands that are provided by the function driver 240 of FIG. 2.

Referring to FIGS. 1-3, at an operation 302, the function driver 240 may cause the processor 202 to generate a query to determine the presence of data to be read on a bulk endpoint of the communication device 230. In some embodiments, the device 230 may be a USB device, including a wired USB device or USB devices that are attached to the computing system 200 via external USB ports or internal mini-PCIe (mini peripheral component interconnect express) slots, for example, via MCH 208. The host controller 224 may transmit the generated query of operation 302 via an interrupt (INT) endpoint (EP) of the communication device 230 at an operation 304. At an operation 306, the processor 202 may wait for an event occurrence. The events at operation 306 may include any of the following: all buffer(s) returned, response received on interrupt EP, or timer expiration.

If the controller 224 receives a response on an interrupt EP at operation 306, at an operation 308, the processor 202 may determine the data size count (e.g., byte count) of the data to be read over the bulk EP of the communication device 230. At an operation 310, the processor 202 may post a sufficient number of buffers 238 to read the amount of data indicated at operation 308 on the bulk endpoint of the communication device 230. At an operation 312, a timer may be started or restarted (e.g., by the processor 202 or other logic). The timer of operation 312 may be any type of a timer, including a hardware timer, a software-based timer, or combinations thereof. After operation 312, the method 300 may resume at operation 306.

At operation 306, once all the buffer(s) 238 posted at operation 310 are returned, at an operation 320, the processor 202 may process any data in the buffers 238. At operation 320, the processor 202 may further unravel packet boundaries. For example, the unraveling may be used to determine whether a debit has occurred due to roundup while posting buffers at operation 310. Additionally, the received data size count (e.g., byte count) may be used to determine the amount of debit. Generally, a debit may occur if a device sends more data than the byte count specified in the previous query response on the interrupt EP. This may happen if the device supplies a byte count that is not a multiple of the endpoint's maximum packet size and then receives more data which may be appended to the bulk endpoint queue before a host reads the data. For example, partial Internet Protocol (IP) packets may be buffered, resulting in a debit which is subsequently utilized to adjust the next IRP(s) (I/O Request Packet(s)). At an operation 322, the processor 202 may determine whether a withdrawing event has occurred (e.g., at an operation 330). If no withdrawing event has occurred, the processor 202 may cancel the timer at an operation 324. Otherwise, at an operation 326, the processor 202 may perform various error recovery operations, e.g., clearing the debit, discard partial IP packets, etc. After operation 326, the method 300 may resume at operation 302.

Alternatively, if at operation 306 the timer expires (e.g., the timer of operation 312), at an operation 330, the processor 202 may indicate (e.g., by updating the value stored in a hardware register or a value stored in a shared memory such as the memory 212) that a withdrawing event has occurred. In some embodiments, the timer may be started (312) immediately after or substantially simultaneous with the operation 310. Also, the timer may be restarted at operation 312 or canceled at operation 324 such as discussed above. The specific value of the timer may be configurable, for example, in accordance with a given application. For instance, shorter polling periods may result in less latency and reduced buffer requirements on the communication device 230 but also less power savings. At an operation 332, the buffer(s) posted at operation 310 may be withdrawn by the processor 202. At an operation 334, the processor 202 may report an error (e.g., to a user, including a system developer) which may be indicative of physical (e.g., thermal) issues with the hardware, a bug in the function driver 240, etc. After operation 334, the method 300 may resume at operation 306.

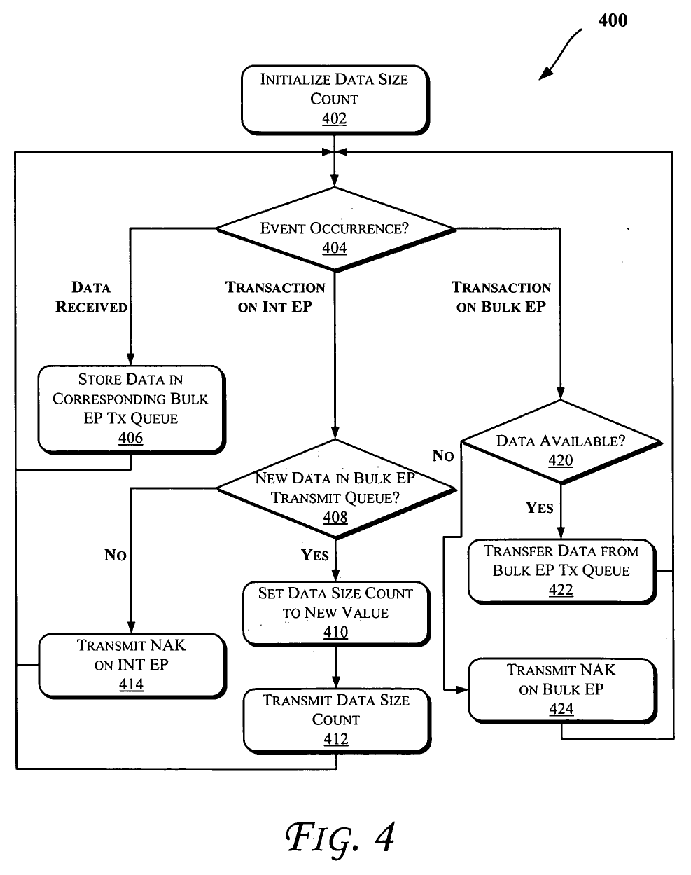

FIG. 4 illustrates a flow diagram of a method 400, according to some embodiments. In some embodiments, various components discussed with reference to FIGS. 1-2 and 5 may be utilized to perform one or more of the operations discussed with reference to FIG. 4. For example, the communication device controller 254 may be configured to perform one or more of the operations discussed with reference to FIG. 4, e.g., in accordance with instructions or commands that are provided via the firmware stored in the storage device 260 of FIG. 2.

Referring to FIGS. 1-4, at an operation 402, the controller 254 may initialize the data size count (e.g., a byte count) of data that is available to be transferred to the host controller 224 on a bulk EP of the communication device 230. The data size count of operation 402 may be stored in any storage device accessible by the controller 254, such as the memory 256. At an operation 404, the controller 254 may wait for the occurrence of an event that may be any of: (a) downlink data received; (b) transaction received on interrupt EP; and/or (c) transaction received on bulk EP. If at operation 404 downlink data is received, the controller may store the received data in corresponding bulk EP transmit queue(s) at an operation 406. For example, data received from the network 102 may be stored in buffers within the memory 256 for transmission to the host controller 224 such as discussed with reference to FIG. 3. After operation 406, the method 400 may resume at operation 404.

If at operation 404 a transaction is received on the interrupt EP of the communication device 230, at an operation 408, the controller 254 may determine whether new data is present in bulk EP transmit queue (that may be stored in the memory 256), e.g., since a last poll or query (e.g., such as the query of operation 302 and 304). If there is new data in the transmit queue, at an operation 410, the controller 254 may set the data size count to a new value that corresponds to the size of the new data of operation 408. At an operation 412, the controller 254 may cause transmission of the data size count of operation 410 to the host controller 224 and thereafter the method 400 may resume at operation 404. In some embodiments, the processor 202 may address cases of overdrawn number of buffers at operation 310 since at operation 412 the new data size count is transmitted. Alternatively, the controller 254 may ensure that the number of bytes transferred is no more than the number of bytes available reported during the last interrupt EP poll. Additionally, since the communication device 230 may be transferring data as a stream of bytes in some situations, the function driver 240 may be configured to deal with situations where a partial IP packet is received or the first received packet has no or a partial IP header 246A information. If no new data is present at operation 408, the controller 254 may transmit a NAK on the interrupt EP at operation 414. After operation 414, the method 400 may resume at operation 404.

Alternatively, if at operation 404 a transaction is received on the bulk EP of the communication device 230, at an operation 420, the controller 254 may determine whether any data is available for transfer. If data is available for transfer, at an operation 422, the controller 254 may transfer the data over the bulk EP via the bus 222. Then, the controller 224 may transfer data from the bulk EP to the buffers 238. Otherwise, if data is unavailable for transfer at operation 420, the controller 254 may transmit a NAK on the bulk EP to the host controller 224 at an operation 424. After operations 422 and 424, the method 400 may resume at operation 404.

Even though various embodiments have been discussed herein with reference to two types of USB data transfers (e.g., bulk transfer and interrupt transfer), the techniques discussed herein may also be applied in other implementations, e.g., where an unpredictable amount of data is to be transferred (e.g., in a bulk data transfer mode) between a host computing system and a communication device. Furthermore, some of the embodiments may be applied to reduce power consumption at idle time during which a host may be requesting data but there is no data available to be read from a communication device. Additionally, some of the embodiments discussed herein may be provided with no changes to existing system software (such as the device driver 236) or host controller (e.g., controller 224).

FIG. 5 illustrates a computing system 500 that is arranged in a point-to-point (PtP) configuration, according to some embodiments of the invention. In particular, FIG. 5 shows a system where processors, memory, and input/output devices are interconnected by a number of point-to-point interfaces. One or more of the devices 104-114 discussed with reference to FIG. 1 may include the system 500. Also, the operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to couple with memories 510 and 512. The memories 510 and/or 512 may store various data such as those discussed with reference to the memory 212 of FIG. 2. For example, each of the memories 510 and/or 512 may include one or more of the O/S 232, application 234, drivers 236 and 240, and/or buffers 238.

The processors 502 and 504 may be any type of processor such as those discussed with reference to the processors 202 of FIG. 2. The processors 502 and 504 may exchange data via a point-to-point (PtP) interface 514 using PtP interface circuits 516 and 518, respectively. The processors 502 and 504 may each exchange data with a chipset 520 via individual PtP interfaces 522 and 524 using point to point interface circuits 526, 528, 530, and 532. The chipset 520 may also exchange data with a high-performance graphics circuit 534 via a high-performance graphics interface 536, using a PtP interface circuit 537.

Each of the processors 502 and 504 may include one or more processor cores 538 and 539, respectively. Some embodiments of the invention may exist in circuits, logic units, or devices within the system 500 of FIG. 5. Furthermore, other embodiments of the invention may be distributed throughout several circuits, logic units, or devices illustrated in FIG. 5.

The chipset 520 may be coupled to a bus 540 using a PtP interface circuit 541. The bus 540 may have one or more devices coupled to it, such as a bus bridge 542 and I/O devices 543:. Via a bus 544, the bus bridge 542 may be coupled to other devices such as a keyboard/mouse 545, communication devices 546 (such as modems, network interface devices, etc.), an audio device 547, and/or a data storage device 548. The data storage device 548 may store code 549 that may be executed by the processors 502 and/or 504. For example, the packet 246 discussed with reference to FIG. 2 may be transmitted to or received from the network 102 by the system 500 through the communication devices 546. The packet 246 may also be received through the I/O devices 543, or other devices coupled to the chipset 520. Furthermore, in some embodiments, one or more of the I/O devices 543, communication devices 546, and/or audio devices 547 may include the firmware storage device 260.

In some embodiments of the invention, the operations discussed herein, e.g., with reference to FIGS. 1-5, may be implemented by hardware (e.g., circuitry), software, firmware, microcode, or combinations thereof, which may be provided as a computer program product, e.g., including a machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-5. Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “an embodiment,” “one embodiment,” or “some embodiments” means that a particular feature, structure, or characteristic described in connection with the embodiment may be included in at least an implementation. The appearances of the phrase “in some embodiments” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first logic to generate a query to determine a presence of data to be transmitted on a bulk endpoint of a communication device; and
a second logic to transmit the query to the communication device via an interrupt endpoint of the communication device.

2. The apparatus of claim 1, wherein the communication device comprises a third logic to cause transmission of a signal to the second logic, wherein the signal corresponds to a number of bytes available to be transmitted on the bulk endpoint of the communication device after the third logic determines the presence of data to be transmitted on the bulk endpoint of the communication device.

3. The apparatus of claim 2, wherein the first logic posts a sufficient number of buffers to store the number of bytes available to be transmitted on the bulk endpoint of the communication device.

4. The apparatus of claim 2, further comprising a memory to store one or more buffers, wherein the first logic posts a sufficient number of the one or more buffers to store the number of bytes available to be transmitted on the bulk endpoint of the communication device.

5. The apparatus of claim 2, wherein the first logic issues a next query to determine whether a next data transfer is to be initiated.

6. The apparatus of claim 5, wherein the second logic transmits the next query to the communication device via the interrupt endpoint of the communication device.

7. The apparatus of claim 1, wherein the communication device comprises a third logic to cause transmission of a not acknowledged signal to the second logic after the third logic determines that no data is present to be transmitted on the bulk endpoint of the communication device.

8. The apparatus of claim 1, further comprising a chipset that comprises the second logic.

9. The apparatus of claim 1, further comprising a processor core that comprises the first logic.

10. The apparatus of claim 1, wherein the communication device is coupled to a wireless computer network.

11. The apparatus of claim 1, further comprising a universal serial bus to couple the second logic and the communication device.

12. A method comprising:
generating a signal to determine a presence of data to be read on a bulk endpoint of a communication device; and
transmitting the signal to the communication device via an interrupt endpoint of the communication device.

13. The method of claim 12, further comprising transmitting a signal corresponding to a number of bytes available to be read on the bulk endpoint of the communication device after determining the presence of data to be read on the bulk endpoint of the communication device.

14. The method of claim 13, further comprising transmitting more data over the bulk endpoint than is identified by the number of bytes.

15. The method of claim 12, further comprising posting a sufficient number of buffers to store a number of bytes available to be read on the bulk endpoint of the communication device.

16. The method of claim 12, further comprising transmitting a not acknowledged signal after determining that no data is present to be read on the bulk endpoint of the communication device.

17. The method of claim 12, further comprising withdrawing one or more buffers after the communication device fails to transmit data to be stored in the one or more buffers within a select time period following posting of one or more buffers to store a number of bytes available to be read on the bulk endpoint of the communication device.

18. The method of claim 12, further comprising transmitting a next signal to the communication device to determine when a next transfer is to be initiated after the data to be read on the bulk endpoint of the communication device has been transferred.

19. The method of claim 18, further comprising transmitting the next signal via the interrupt endpoint of the communication device.

20. A computer-readable medium comprising one or more instructions that when executed on a processor configure the processor to:
generate a query to determine a presence of data to be read on a bulk endpoint of a communication device; and
transmitting the query to the communication device via an interrupt endpoint of the communication device.

21. The computer-readable medium of claim 20, further comprising one or more instructions that configure the processor to post a sufficient number of buffers to store a number of bytes available to be read on the bulk endpoint of the communication device.

22. The computer-readable medium of claim 20, further comprising one or more instructions that configure the processor to withdraw one or more buffers after the communication device fails to transmit data to be stored in the one or more buffers within a select time period following posting of one or more buffers to store a number of bytes available to be read on the bulk endpoint of the communication device.

23. A system comprising:
a display device to display one or more images;
a processor coupled to the display device and configured to generate a query to determine a presence of data to be read on a bulk endpoint of a communication device; and
a chipset to transmit the query to the communication device via an interrupt endpoint of the communication device.

24. The system of claim 23, wherein the display device comprises a flat panel display.

25. The system of claim 23, wherein the communication device comprises a third logic to cause transmission of a signal to the chipset, wherein the signal corresponds to a number of bytes available to be read on the bulk endpoint of the communication device after the third logic determines the presence of data to be read on the bulk endpoint of the communication device.
